(19) United States
(12) Patent Application Publication
(10) Pub. No.: US 2010/0096535 A1
(43) Pub. Date: Apr. 22, 2010

(54) POSITION SENSOR

(75) Inventors: Nir KARASIKOV, Haifa (IL); Gal PELED, Kibbutz Ein Hachoresh (IL); Borris ALEXANDROVICH, Kiryat Ata (IL); Leonardo BLANGA, Haifa (IL)

Correspondence Address: Allan C. Entis Ph.D., Intellectual Property Ltd., 6 Raoul Wallenberg Street, Ramat Hachayal, Tel Aviv, 69719, IL

(73) Assignee: NANOMOTION LTD., Yokneam (IL)

(21) Appl. No.: 12/581,194

(22) Filed: Oct. 19, 2009

Related U.S. Application Data
(60) Provisional application No. 61/106,582, filed on Oct. 19, 2008.

(51) Int. Cl. H01J 40/14; G01B 11/14

(52) U.S. Cl. 250/206

(57) ABSTRACT

A position sensing device (PSD) comprising: a light source that provides light responsive to current that it receives; a power source that provides current to the light source through a load line; a photodetector that receives an amount of light from the light source that is a function of position of the light source relative to the photodetector; and an integrated circuit comprising an I/O port connected to the light source and having a plurality of selectable states; wherein different selectable states determine different values for the load line and therefore current provided to the light source.

### CROSS-REFERENCES TO RELATED APPLICATIONS

The present application claims benefit under 35 U.S.C. §119(e) of U.S. Provisional Application 61/106,582 filed Oct. 19, 2008, the entire content of which is incorporated herein by reference.

### FIELD OF THE INVENTION

The invention relates to position sensors, and in particular to position sensors used to position an element in an optical system.

### BACKGROUND OF THE INVENTION

Various position sensing devices (PSDs), such as for example, reflective, moiré, and fiducial sensing PSDs, and methods are known in the art for accurately determining position of a moveable element in small mechanical systems accurately machined to relatively fine tolerances. Optionally, signals generated by a PSD in a mechanical system are used to control a motor or actuator used to move and position a moveable element in the system. For example, small optical systems, such as cell-phone cameras, generally require at least one position-sensing device (PSD) to provide data for determining position or orientation of a lens in the camera. Optionally, signals provided by the PSD are used to control the motor or actuator that moves or orients the lens.

Reflective PSDs comprise a light source, photodetector and a reflective surface, which are positioned so that light from the light source reflected by the reflective surface and sensed by the photodetector is dependent on a distance to a moveable element to be measured. Signals generated by the photodetector responsive to the reflected light that it receives are used to determine motion of and/or distance to the moveable element. Moiré PSDs comprise a moiré pattern of fringes generated by first and second periodic patterns for determining position and/or motion of a moveable element. Motion of the fringes is used to determine motion and/or position of the moveable element. Fiducial sensing PSDs typically comprise a photodetector that images fiducials that move when a moveable element whose position and/or motion is to be determined moves. Position and/or motion of the imaged fiducials is used to determine location and/or motion of the moveable element.

PCT publication WO 2006/035447, the disclosure of which is incorporated herein by reference, describes platform transport systems, optionally for use in positioning a lens or lenses in a small camera. The transport systems comprise at least one platform to which a lens is mounted that is moved along an optic axis of the camera. In some camera embodiments described in the PCT publication, a PSD, optionally of a type noted above, is used to monitor position of a platform in the transport system to which a lens is mounted, and thereby position of the lens, along the optical axis.

### SUMMARY OF THE INVENTION

An aspect of some embodiments of the invention relates to providing an improved position-sensing device, PSD, for determining position of a moveable element. Optionally the PSD is a reflective PSD. Optionally, the moveable element is an element of an optical system. Optionally, the optical system is an optical system comprised in a camera.

An aspect of an embodiment of the invention relates to providing a method of controlling output of a light source that provides light in a reflective PSD.

In an embodiment of the invention, a reflective PSD for determining position of a moveable element comprises a light source, a photodetector, and a reflective surface. The light source and photodetector are positioned so that light from the light source is reflected by the reflective surface to the photodetector, and an amount of reflected light sensed by the photodetector is a function of distance to the moveable element that is to be determined Output signals that the photodetector generates responsive to the reflected light that it senses are used to determine distance to the moveable element. Optionally, the light source and photodetector are located adjacent each other at substantially a same distance from the reflective surface. Optionally, the reflective element is mounted to the moveable element and the light source and photodetector are mounted on a body from which distance to the moveable element is to be determined. Alternatively, the light source and photodetector are mounted to the moveable element and the reflective element is mounted to a body from which distance to the moveable element is to be determined. In an embodiment of the invention, the light source comprises an LED and the photodetector comprises a photodiode.

According to an aspect of some embodiments of the invention, a standard input/output (I/O) of an integrated circuit (IC), optionally an application specific IC (ASIC), is used to control current provided to the light source. In an embodiment of the invention an ASIC is used to control voltage to the light source. In an embodiment of the invention, the current or voltage is controlled so that output of the photodetector is substantially linear with distance for a desired dynamic range of distances to be measured.

Photodiodes used in reflective PSDs can vary widely in sensitivity and light sources, such as LEDs used in the PSDs can vary widely in intensity of light they produce for a same input current provided by a circuit to the light source. Adjusting a circuit that controls current to a light source or photodetector in a PSD to compensate for peculiarities of the light source and/or photodetector so that the PSD provides a stable and reliable output as a function of distance can be relatively complicated and expensive. In particular, adjusting the circuit can be complicated and expensive if dedicated, variable components must be added to the circuit so that it can be properly adjusted.

The inventors have realized that for many applications, a PSD is used in a system comprising an IC having a plurality of standard I/O ports that conventionally provide three output states. By connecting at least one of the I/O ports to the circuit that provides current to the light source, the circuit can relatively easily be adjusted to provide a desired current to the light source and a PSD output, which is substantially linear with distance in a desired dynamic distance range.

In an embodiment of the invention voltage to the light source is controlled by a pulse generator having a controllable pulse rate.

There is therefore provided in accordance with an embodiment of the invention a position sensing device (PSD) comprising: a light source that provides light responsive to current that it receives; a power source that provides current to the light source through a load line; a photodetector that receives an amount of light from the light source that is a function of position of the light source relative to the photodetector; and an integrated circuit comprising an I/O port connected to the light source and having a plurality of selectable states; wherein different selectable states determine different values for the load line and therefore current provided to the light source. Optionally, the light source is connected to a first load resistor. Optionally, the light source and I/O port are connected by a second load resistor. Optionally, the load resistors are connected at a common node. Optionally, the I/O port has three selectable states.

There is further provided in accordance with an embodiment of the invention A position sensing device (PSD) comprising: a light source that provides light responsive to current that it receives; a photodetector that receives an amount of light from the light source that is a function of position of the light source relative to the photodetector; and an integrated circuit having: an I/O port connected to the light source; a pulse generator that provides voltage pulses; a low pass filter that receives the pulses and provides a DC voltage responsive thereto at the I/O port; and a controller that controls duty cycle of the pulses to control magnitude of the DC voltage; wherein voltage at the I/O port determines current provided to the light source.

### BRIEF DESCRIPTION OF FIGURES

Embodiments of the invention will be more clearly understood by reference to the following description of embodiments thereof read in conjunction with the figures attached hereto. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale. The figures are listed below.

FIG. 1A schematically shows a configuration of a light source and photodetector of a PSD comprised in a camera, in accordance with an embodiment of the invention;

FIG. 1B schematically shows an enlarged view of a portion of the camera comprising the PSD shown in FIG. 1A, in accordance with an embodiment of the invention;

FIG. 2 shows a graph of output current for the photodetector as a function of distance in accordance with an embodiment of the invention;

FIG. 3 shows a schematic of the light source shown in FIG. 1 connected to an I/O of an integrated circuit to control current to the light source, in accordance with an embodiment of the invention; and

FIG. 4 schematically shows the light source shown in FIG. 1 connected to an adjustable voltage source, in accordance with an embodiment of the invention.

### DETAILED DESCRIPTION

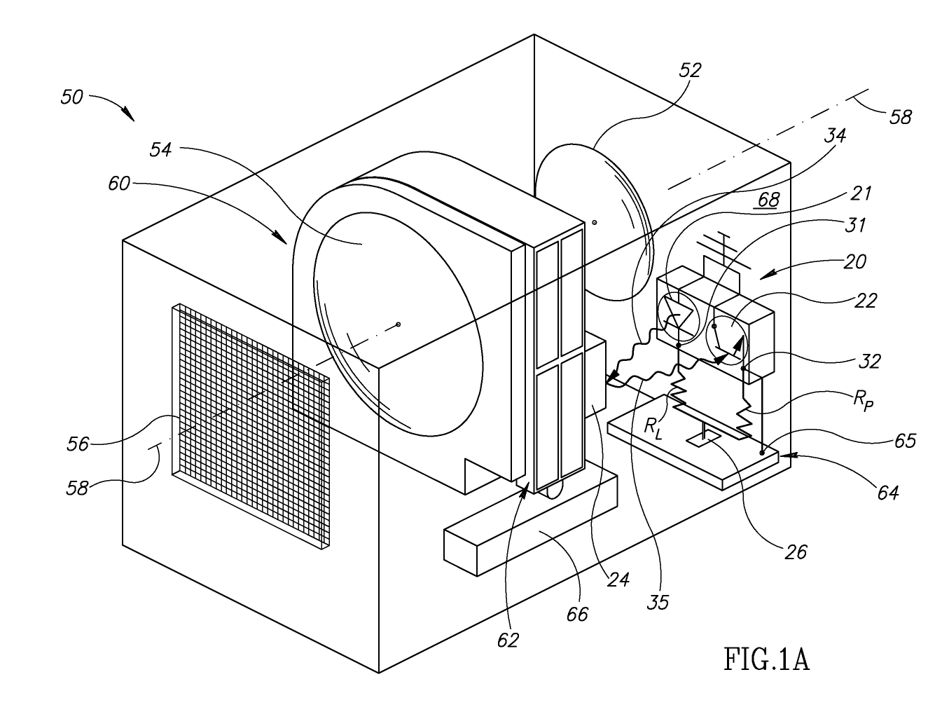

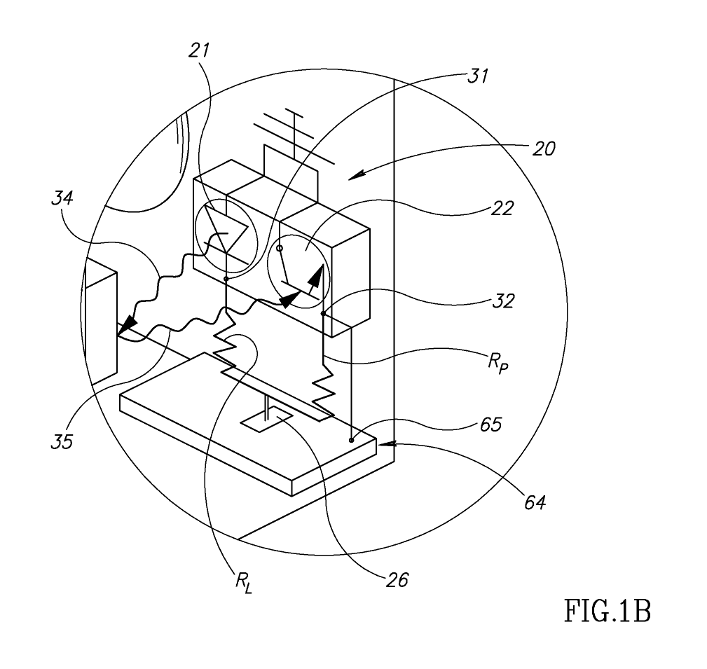

FIG. 1A schematically shows components of a PSD 20 by way of example mounted to a camera 50, in accordance with an embodiment of the invention. FIG. 1B schematically shows an enlarged view of PSD 20 shown in FIG. 1A. Camera 50, is shown very schematically and comprises a collecting lens 52 for collecting light from a scene (not shown) imaged by the camera, a focusing lens 54 and a photosurface 56 aligned along a camera optic axis 58. The focusing lens is fitted to a moveable platform 60, which is optionally mounted with a piezoelectric motor 62. The motor is controlled by a suitable camera controller, optionally an ASIC 64, to apply force to a contact plate 66 to move and position the platform and thereby the focusing lens along optic axis 58 so that the focusing lens focuses light from the scene collected by the collecting lens on the photosurface. Cameras similar to camera 50 are described in PCT publication WO 2006/035447 referenced above.

PSD 20 comprises a light source, optionally a LED 21, and a photodetector, optionally a photodiode 22, mounted adjacent to each other, optionally on a wall 68 of camera 50 so that they are stationary relative to optic axis 58. A reflecting surface 24, hereinafter “reflector 24”, is fixed to, or formed on, platform 60 so that it moves with the platform and is oriented so that it reflects light emitted by LED 21 to photodiode 22.

LED 21 is optionally connected by a resistor R_{L} at a node 31 to a suitable, optionally regulated power supply 26, optionally comprised in ASIC 64, which provides an operating voltage V_{cc} and a current limited by resistor R_{L} to the LED to cause it to emit light. Photodiode 22 is optionally back-biased by power supply 26 through a resistor R_{P} connected to the photodiode at a node 32. The photodiode draws an amount of current through the resistor that is dependent on an amount of light incident on the photodiode. In FIGS. 1A and 1B, light emitted by LED 21 that is incident on reflector 24 is represented by a wavy arrow 34 and light that is reflected by reflector 24 to photodiode 22 is represented by a wavy arrow 35.

For a given current provided by power supply 26 to LED 21, an amount of reflected light 35 that reaches photodiode 22 is dependent on distance of LED 21 from reflector 24 and therefore on position of platform 60 and focusing lens 54 along optic axis 58. As an amount of current I_{P} drawn by photodiode 22 through resistor R_{P} is a function of an amount of reflected light incident on the photodiode, I_{P} is also a function of position of platform 60 and therefore of focusing lens 54 along optic axis 58. Voltage at node 32 is proportional to current I_{P} and is optionally used as a signal indicative of the current and thereby of position of focusing lens 54 along optic axis 58. In an embodiment of the invention, the signal is used in a closed loop control circuit to control piezoelectric motor 62 to move and position focusing lens 54 along optic axis 58 to properly focus light from a scene imaged by camera 50 on photosurface 56. Optionally, as shown in FIGS. 1A and 1B, node 32 is connected to an I/O port 65 of ASIC 64 and the ASIC processes the voltage signal at the node to determine position of focusing lens 54 along optic axis 58 and use the determined position to control piezoelectric motor 62.

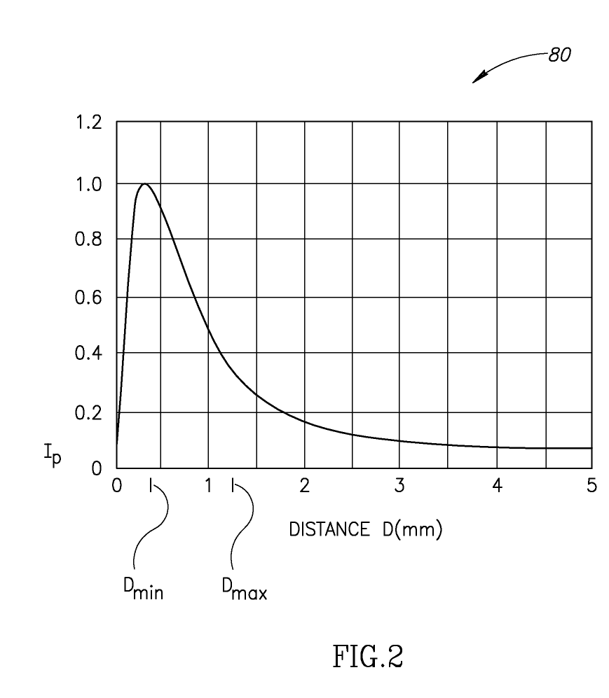

FIG. 2 shows a graph 80 of current I_{P} flowing through resistance R_{P} as a function of distance “D” between LED 21 and reflector 24, which distance determines an amount of light from the LED that is incident on photodiode 22. Distance D between LED 21 and reflector 24 is given in mm along the abscissa of graph 80 and values of current I_{P} normalized to a maximum current are indicated along the graph ordinate.

Graph 80 shows that for D in a range bounded by a minimum Dₘᵢₙ equal to about 0.4 mm and a maximum Dₘₐₓ mm equal to about 1.2 mm, current I_{P} is substantially linear as a function of distance D. I_{P} is therefore linear with distance in a range, a linear range “LR”=(Dₘₐₓ−Dₘᵢₙ), of distances D equal to about 0.8 mm For PSD 20 to provide relatively accurate and reliable measurements of distance D, it can be advantageous for D to be limited to the range LR. Therefore, in an embodiment of the invention, components of PSD 20 are configured so that for a range of positions of focusing lens 54 required for satisfactory focusing of camera 50, D is limited to a range coextensive with or contained in LR. The inventors have found that for PSD 20 limited to a range coextensive with or contained in LR, the PSD can provide measurements of position of platform 60 and therefore focusing lens 54 along optic axis 58 with an accuracy of less than or equal to about 5 microns.

It is noted that whereas graph 80 was determined for a specific configuration of components and operating conditions of PSD 20, graph 80 is expected to be generally representative for a variety of components and operating conditions of a PSD similar to PSD 20. For a given distance measurement application, components and operating conditions of a PSD in accordance with an embodiment of the invention are positioned so that the PSD operates in a range coextensive with or contained in linear range LR of the PSD.

By way of example, assume that a PSD, in accordance with an embodiment of the invention, similar to PSD 20, comprises a LED 21, a photodiode 22 and a reflector 24 matched to resistances R_{L} and R_{P} and an operating voltage V_{cc}, that define a characteristic curve of Iₚ as a function of distance similar to that in graph 80. Further, assume that the PSD is to be used to determine position of a lens along an optic axis of a camera, optionally similar to camera 50. Let LPₘᵢₙ and LPₘₐₓ represent minimum and maximum positions that bound positions of the lens along the camera optical axis that are used for camera operation. Then, in accordance with an embodiment of the invention, LED 21, photodiode 22 and reflector 24 are positioned in the camera so that LPₘᵢₙ and LPₘₐₓ are bounded Dₘᵢₙ and Dₘₐₓ. In symbols, LPₘᵢₙ and LPₘₐₓ are required to satisfy an operating constraint Dₘᵢₙ≦LPₘᵢₙ<LPₘₐₓ≦Dₘₐₓ.

The inventors have noted however that, generally, characteristics of a particular LED of a given type of LED and/or a particular photodiode of a given type of photodiode can vary widely. As a result, a given set of values R_{L}, R_{P}, and V_{cc} can generally not be relied upon to assure that for a given LED 21 and/or given photodiode 22 of types to be used in PSD 20, the operating constraint Dₘᵢₙ≦LPₘᵢₙ<LPₘₐₓ≦Dₘₐₓ is satisfied. Furthermore for a mass produced product, adjusting R_{L}, R_{P}, and V_{cc} to compensate for variances in the characteristics of individual LEDs and/or photodiodes can be prohibitively time consuming and expensive.

To relatively easily and inexpensively compensate for variances in the characteristics of individual LEDs and/or photodiodes in a reflective PSD, such as PSD 20, the inventors have determined that a standard I/O port, optionally in an ASIC, such as ASIC 64 used to control camera 50, can be used to adjust current to LED 21.

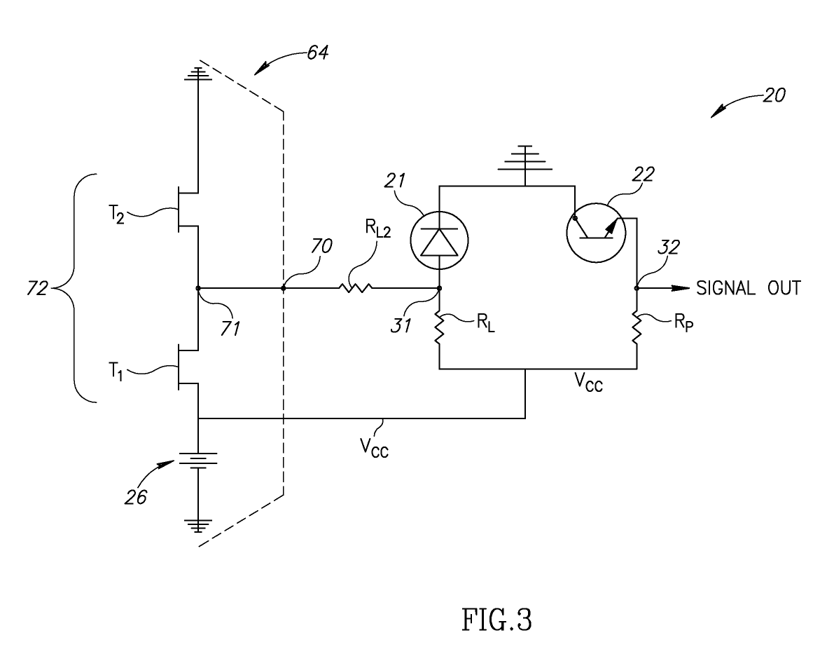

FIG. 3 schematically shows PSD 20 shown in FIGS. 1A and 1B connected to an I/O port 70 in ASIC 64, indicated by a dashed line, to control current in LED 21 of the PSD, in accordance with an embodiment of the invention. FIG. 3 shows only a portion of PSD 20 and circuit elements of the ASIC that define operation of the I/O port.

I/O port 70 is typically connected to a node 71 between two transistors T₁ and T₂ of a two transistor chain 72 comprised in ASIC 64. The port, and thereby node 71 is connected to node 31 at which resistor R_{L} is connected to LED 21 by a resistor R_{L2}. Transistor chain 72 is connected at one end to ground and at the other end to regulated voltage V_{cc} optionally provided by power supply 26 of ASIC 64 to which resistor R_{L} is connected.

Transistor chain 72 has three states that are used to control an amount of current generated by V_{cc} through LED 21 and thereby intensity of light provided by LED 21, in accordance with an embodiment of the invention. In a first state, transistors T₁ and T₂ are both turned off, and resistor R_{L2} has substantially no effect on current through LED 21. Current through LED 21 has a value I₁, which is limited by a load line determined only by resistor R_{L} and the current is generally close to V_{cc}/R_{L}. LED 21 emits light with an intensity φ₁ corresponding to current I₁. In a second state, transistor T₁ is turned on and transistor T₂ is turned off, as a result of which, resistor R_{L2} is connected to V_{cc} in parallel with resistor R_{L}. Current through LED 21 has a value I₂, which is limited by a load line determined by resistance (R_{L} and R_{L2} in parallel) that is less than R_{L}. As a result, I₂ is greater than I₁ and LED 21 emits light with an intensity φ₂ greater than intensity φ₁. In a third state, transistor T₁ is turned off and transistor T₂ is turned on, as a result of which, resistor R_{L2} is connected in parallel with LED 21 to ground. Resistor R_{L2} diverts current from LED 21 and current through LED 21 has a value I₃ which is less than I₁ and the LED emits light at an intensity φ₃ which is less than φ₁.

From the above it is seen that by connecting node 31 to an I/O port of ASIC 64, in accordance with an embodiment of the invention, ASIC 64 is controllable, to relatively easily, selectively, provide a current I₁ I₂, or I₃ to LED 21. In an embodiment of the invention, for a given type of LED 21 and/or photodiode 22, resistances R_{L}, R_{L2}, and R_{P} are determined so that at least one of currents I₁ I₂, and I₃, is suitable to compensate for variance in a characteristic of the LED and/or photodiode that might degrade performance of PSD 20. In particular, the ASIC can be controlled to adjust current through LED 21 so that PSD 20 generates an output signal that is linear with distance for a range of distances for which the PSD is intended to provide measurements.

In some embodiments of the invention, node 31 is connected to more than one I/O port of ASIC 64, similarly to the way the node is connected to I/O port 70. The additional connection provides for a greater choice of currents that can be provided to LED 21 by the ASIC. If node 31 is connected to “n” I/O ports of ASIC 64, there are 3ⁿ different configurations of resistors for driving current through LED 21 and, generally, a same number of different currents.

In the above description, a load line that defines current provided to LED 21 is adjusted to compensate for variances in components of PSD 20 and calibrate the PSD so that it operates in a linear regime. In some embodiments of the invention, voltage provided to LED 21 is adjusted to compensate for variances in PSD components. Optionally, a pulse generator and filter in an ASIC provide the adjustable voltage.

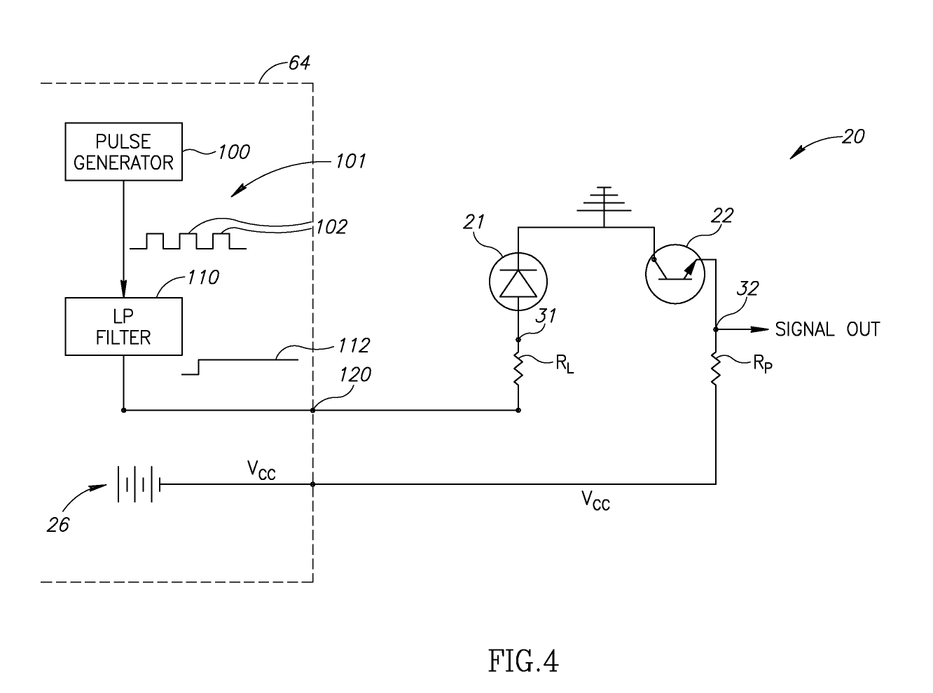

By way of example, FIG. 4 schematically shows ASIC 64 provided with an adjustable voltage source connected to LED 21 comprised in PSD 20, in accordance with an embodiment of the invention. ASIC 64 optionally comprises a pulse generator 100 controllable to provide a train 101 of voltage pulses 102 having variable width and optionally same amplitude. Pulse train 101 is input to a low pass filter 110 that filters the pulse train to provide an output DC voltage level at an I/O port 120 responsive to the pulses.

In accordance with an embodiment of the invention, the output DC voltage provided at I/O port 120 is adjusted to provide a desired DC voltage, schematically represented by height of a step function 112 by adjusting widths of pulses 102 generated by the pulse generator. To increase the output DC voltage, pulse widths provided by the pulse generator are increased and to decrease the output voltage, pulse widths provided by the pulse generator are decreased. Resistor R_{L} connects I/O port 120 to LED 21 and the output DC voltage at the port is controlled to excite the LED to emit a desired intensity of light. Optionally, resistor R_{P} connects LED 22 to power supply 26 in ASIC 64, which power supply provides a voltage V_{cc} to resistor R_{P}.

It is noted that whereas in the above description a PSD in accordance with an embodiment of the invention is configured as a reflective PSD, PSDs in accordance with an embodiment of the invention are not limited to reflective PSDs. For example, a PSD in accordance with an embodiment of the invention comprises a photosensor that optionally faces a light source and receives light directly from the light source. Output of an I/O port controls current to the light source to provide a desired correspondence between an output of the PSD and a distance range for which the PSD provides distance measurements.

It is further noted that whereas in the above description current is adjusted responsive to an I/O port output in accordance with an embodiment of the invention to provide a linear output for a PSD, current can of course be adjusted so that a PSD operates in other than a linear regime.

In the description and claims of the present application, each of the verbs, “comprise” “include” and “have”, and conjugates thereof, are used to indicate that the object or objects of the verb are not necessarily an exhaustive listing of members, components, elements or parts of the subject or subjects of the verb.

The invention has been described with reference to embodiments thereof that are provided by way of example and are not intended to limit the scope of the invention. For example, whereas a PSD in accordance with an embodiment of the invention is described as being used in a camera, the PSD is not limited to use in a camera. A PSD such as PSD 20 may be used in many of various other applications. For example, a PSD similar to PSD 20 is optionally used to in accordance with an embodiment of the invention may be used to measure displacement of a diaphragm in an acoustic generator. The described embodiments comprise different features, not all of which are required in all embodiments of the invention. Some embodiments of the invention utilize only some of the features or possible combinations of the features. Variations of embodiments of the described invention and embodiments of the invention comprising different combinations of features than those noted in the described embodiments will occur to persons of the art. The scope of the invention is limited only by the following claims.

1. A position sensing device (PSD) comprising:
a light source that provides light responsive to current that it receives;
a power source that provides current to the light source through a load line;
a photodetector that receives an amount of light from the light source that is a function of position of the light source relative to the photodetector; and
an integrated circuit comprising an I/O port connected to the light source and having a plurality of selectable states;
wherein different selectable states determine different values for the load line and therefore current provided to the light source.

2. A position sensing device according to claim 1 wherein the light source is connected to a first load resistor.

3. A position sensing device according to claim 2 wherein the light source and I/O port are connected by a second load resistor.

4. A position sensing device according to claim 3 wherein the load resistors are connected at a common node.

5. A position sensing device according to claim 4 wherein the I/O port has three selectable states.

6. A position sensing device (PSD) comprising:
a light source that provides light responsive to current that it receives;
a photodetector that receives an amount of light from the light source that is a function of position of the light source relative to the photodetector; and
an integrated circuit having:
an I/O port connected to the light source;
a pulse generator that provides voltage pulses;
a low pass filter that receives the pulses and provides a DC voltage responsive thereto at the I/O port; and
a controller that controls duty cycle of the pulses to control magnitude of the DC voltage; wherein
voltage at the I/O port determines current provided to the light source.
